(19) United States
(12) Patent Application Publication
(10) Pub. No.: US 2026/0259736 A1
(43) Pub. Date: Sep. 3, 2026

(54) SHARED DISPATCH BUFFER ACROSS RESERVATION STATIONS

(71) Applicant: QUALCOMM Incorporated, San Diego, CA (US)

(72) Inventors: Luca MARONCELLI, Austin, TX (US); Yiran HUANG, Cambridge (GB); Sneha Rao GADAMBUR RAVI, Sunnyvale, CA (US)

(21) Appl. No.: 19/067,598

(22) Filed: Feb. 28, 2025

(51) Int. Cl. G06F 9/38; G06F 12/0817

(52) U.S. Cl. CPC G06F 9/3836; G06F 9/3814; G06F 12/0824

(57) ABSTRACT

Aspects presented herein relate to methods and devices for data processing including an apparatus, e.g., a processor. The apparatus may obtain a set of instructions for data storage, where the set of instructions is associated with the data processing. The apparatus may also store each of the set of instructions in a buffer, where the buffer is associated with a set of reservation stations. Further, the apparatus may assign each of the set of instructions to one of the set of reservation stations based on storage of each of the set of instructions in the buffer.

### TECHNICAL FIELD

The present disclosure relates generally to processing systems and, more particularly, to one or more techniques for data processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor or display processing unit (DPU).

A graphics processor of a device may be configured to perform the processes in a graphics processing pipeline. Further, graphics processors may be utilized to perform graphics rendering. However, there has developed an increased need for improved rendering in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a central processing unit (CPU), a streaming mode compute unit (SMCU), a compiler, a central processor, a graphics processing unit (GPU), or any apparatus that may perform data processing. The apparatus may obtain a set of instructions for data storage, where the set of instructions is associated with the data processing. The apparatus may also configure a set of reservation stations for storage of the set of instructions in a buffer. The apparatus may also store each of the set of instructions in a buffer, where the buffer is associated with a set of reservation stations. Additionally, the apparatus may determine at least one of a first available reservation station of the set of reservation stations or a corresponding reservation station of the set of reservation stations for each of the set of instructions. The apparatus may also assign each of the set of instructions to one of the set of reservation stations based on storage of each of the set of instructions in the buffer. Moreover, the apparatus may output an indication to transfer each of the set of instructions from the buffer to one of the set of reservation stations. The apparatus may also remove, based on the indication, each of the set of instructions from the buffer for transfer to one of the set of reservation stations. The apparatus may also send, from the buffer based on the removal, each of the set of instructions to one of the set of reservation stations. The apparatus may also output an indication of assignment of each of the set of instructions to one of the set of reservation stations.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example image or surface in accordance with one or more techniques of this disclosure.

FIG. 5 is a diagram illustrating an example geometry pipeline in accordance with one or more techniques of this disclosure.

FIG. 6 is a diagram illustrating an example GPU hardware in accordance with one or more techniques of this disclosure.

FIG. 7 is a diagram illustrating an example execution sequence in accordance with one or more techniques of this disclosure.

FIG. 8 is a diagram illustrating an example storage process in accordance with one or more techniques of this disclosure.

FIG. 9 is a diagram illustrating an example buffer sharing process in accordance with one or more techniques of this disclosure.

FIG. 10 is a diagram illustrating an example buffer sharing process in accordance with one or more techniques of this disclosure.

FIG. 11 is a diagram illustrating an example buffer sharing process in accordance with one or more techniques of this disclosure.

FIG. 12 is a communication flow diagram illustrating example communications between a CPU, a GPU/CPU, and a memory in accordance with one or more techniques of this disclosure.

FIG. 13 is a flowchart of an example method of data processing in accordance with one or more techniques of this disclosure.

FIG. 14 is a flowchart of an example method of data processing in accordance with one or more techniques of this disclosure.

### DETAILED DESCRIPTION

Some types of CPU extensions (e.g., a streaming mode compute unit (SMCU) or scalable matrix extension (SME)) may not be very low latency. For example, a load into the load store unit (LSU) may take a high amount of cycles (e.g., 60 to 70 cycles) to obtain data. Also, in some instances, the CPU may go straight into the reservation stations for certain executions. For some types of instructions, there may be small buffers that are mostly clear. A CPU may try to accept certain instructions and then eventually execute them at a certain pace. That is, a CPU may want to take a cluster of instructions and then execute them at a certain pace. And these instructions may need to be buffered. Additionally, a load store unit (LSU) may have a high latency compared to a CPU core. So a workload may need to be loaded (e.g., stored into a register) before the workload can be executed. The problem is that the loads may take a certain number of cycles (e.g., 60 to 70 cycles) in order to return the data. If a certain buffer (e.g., matrix execution unit (MXU) buffer) fills up, it can no longer accept any instructions and the whole execution may stall. So because a high number of instructions may need to be accepted, the long latency may be an issue in order to not stop the execution at any point. That is, to be able to process a high number of instructions, the processing may need to be stopped at certain points, which creates issues. For instance, if any point loads are not being sent, there is going to be a time later where there is a gap in the execution of the data path instructions. Thus, a certain buffer size to be able to handle any gap in loads being sent and not have a corresponding gap in execution. Additionally, each execution unit in a CPU extension may have its own buffer. For example, a vector execution unit may have its own buffer for vector instructions (VX), a matrix execution unit may have its own buffer for matrix instructions (MX), and a move execution unit may have its own buffer for move instructions (MU). As such, there may be a large number of buffers for these execution units, which may cause execution gaps if the buffer size does not correspond to the amount of loads being sent. That is, a large amount of buffers may result in a worsening of timing for execution of data workloads. Typical high performance CPU implementation has each reservation station bound to one specific type of instruction, and some dispatch buffers may be needed to decouple the reservation stations with the front end renaming logic. Each dispatch buffer may also hold one specific type of instruction. This allows for dispatch buffer content to be written to corresponding reservation station in as few as one cycle. However, such implementation may need careful sizing of each dispatch buffer considering the expected instruction sequences, and may be suboptimal for specific workloads. In the case of an accelerator design to execute SME instructions, allowing for large out-of-order window with the combined size of dispatch buffer and reservation station is important. However, the latency of dispatch buffer binding to a reservation station is less important, as the main target is a high instruction throughput. Also, having large reservation stations may pose physical design challenges when targeting higher frequencies. Based on the above, it may be beneficial to optimize or improve the amount of buffers at a CPU. Aspects of the present disclosure may optimize or improve the amount of buffers at a CPU.

Aspects of the present disclosure may include a number of benefits or advantages. For instance, aspects of the present disclosure may optimize or improve the amount of buffers at a CPU. Aspects presented herein may reduce the amount of buffers at a CPU, in order to reduce the amount of memory and increase the processing speed of the CPU. That is, aspects presented herein may utilize a large, shared buffer to reduce the amount of buffers at a CPU. Indeed, aspects presented herein may utilize a single, large buffer (e.g., a large dispatch buffer) to be able to handle any gap in loads being sent and not experience a corresponding gap in execution. A large, shared dispatch buffer may bind to all smaller reservation stations, thus achieving a target buffer size with a minimum area overhead. Aspects presented herein may also allow the buffer design to have smaller size for each reservation station while still allowing for a large out-of-order window for all instruction types with any instruction sequences. This is beneficial to keep the area cost down at the CPU, but also helpful when pushing for a higher frequency physical design. Aspects presented herein may also share a data entry storage across multiple data reservation stations via a linked list (i.e., a linear collection of data elements whose order is not given by their physical placement in memory), rather than storing it in a buffer. So aspects presented herein may utilize multiple reservation stations per a single buffer. By adding multiple reservation stations for a single buffer, aspects presented herein may optimize the amount of buffers, which may reduce the amount of memory and increase the processing speed of the CPU. In turn, this may optimize or improve the overall performance of a CPU.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended. In some examples, as used herein, the term “graphics workload” may refer to any workload or order associated with graphics processing. In some examples, as used herein, the term “texture fetch” may refer to a memory request, which incurs transactions from a cache (e.g., a texture cache). Each time a warp executes a texture function to read from texture memory, this may be a single texture fetch. Also, texture memory may be read-only device memory, and may be accessed using the device functions described in a texture function. Reading a texture using one of these functions may be called a “texture fetch.” A “render target” may refer to a target block of pixels (buffer) into which rendering will occur. In some aspects, a render target may refer to a buffer where the pixels are drawn (e.g., a video card draws pixels) for a scene that is being rendered in the background. An intermediate render target may refer to a render target that is used in post-processing.

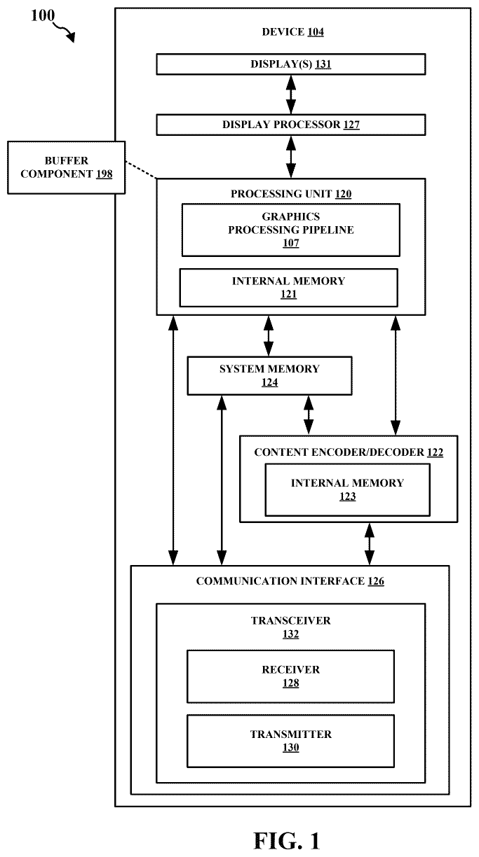

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a buffer component 198 configured to obtain a set of instructions for data storage, where the set of instructions is associated with the data processing. The buffer component 198 may also be configured to configure a set of reservation stations for storage of the set of instructions in a buffer. The buffer component 198 may also be configured to store each of the set of instructions in a buffer, where the buffer is associated with a set of reservation stations. The buffer component 198 may also be configured to determine at least one of a first available reservation station of the set of reservation stations or a corresponding reservation station of the set of reservation stations for each of the set of instructions. The buffer component 198 may also be configured to assign each of the set of instructions to one of the set of reservation stations based on storage of each of the set of instructions in the buffer. The buffer component 198 may also be configured to output an indication to transfer each of the set of instructions from the buffer to one of the set of reservation stations. The buffer component 198 may also be configured to remove, based on the indication, each of the set of instructions from the buffer for transfer to one of the set of reservation stations. The buffer component 198 may also be configured to send, from the buffer based on the removal, each of the set of instructions to one of the set of reservation stations. The buffer component 198 may also be configured to output an indication of assignment of each of the set of instructions to one of the set of reservation stations. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

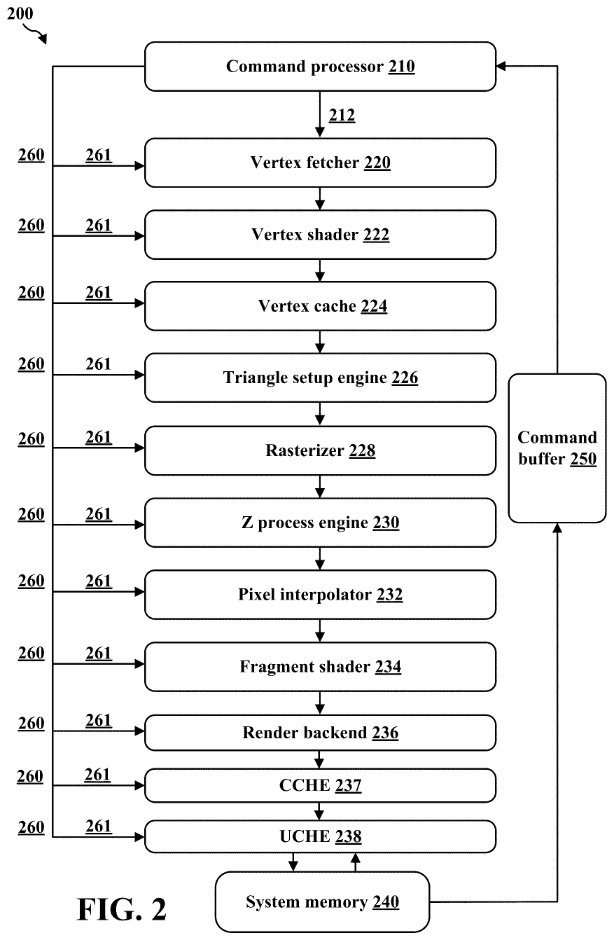

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in double data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

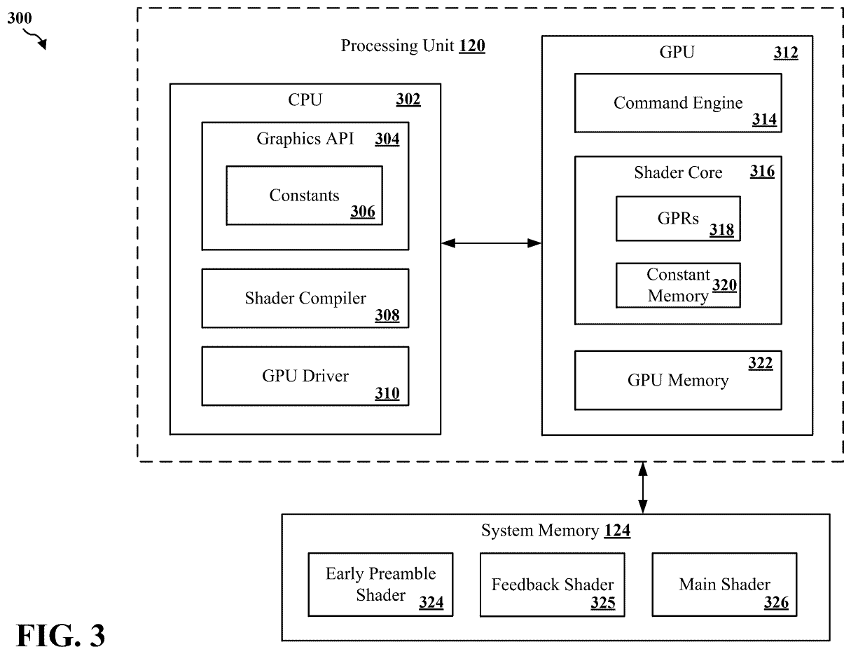

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

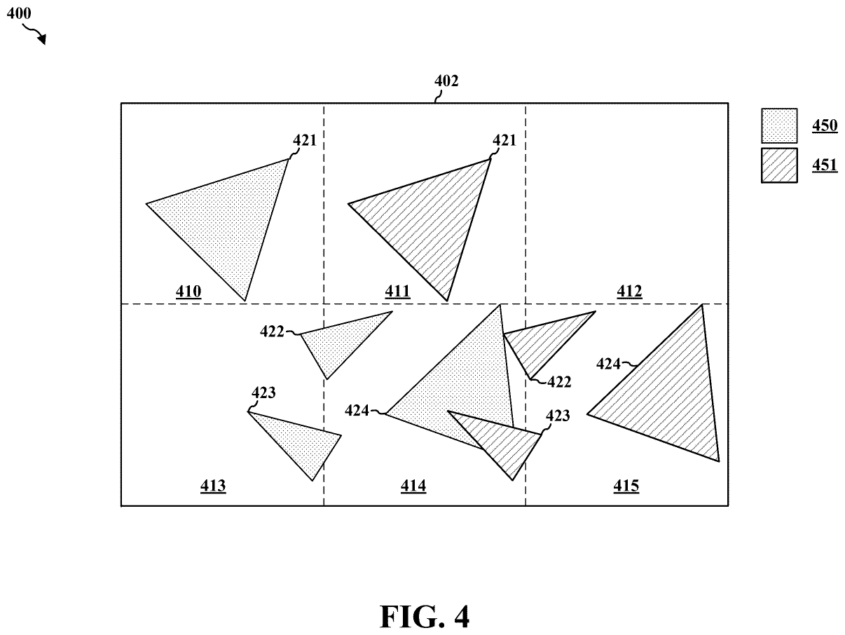

FIG. 4 illustrates image or surface 400, including multiple primitives divided into multiple bins. As shown in FIG. 4, image or surface 400 includes area 402, which includes primitives 421, 422, 423, and 424. The primitives 421, 422, 423, and 424 are divided or placed into different bins, e.g., bins 410, 411, 412, 413, 414, and 415. FIG. 4 illustrates an example of tiled rendering using multiple viewpoints for the primitives 421-424. For instance, primitives 421-424 are in first viewpoint 450 and second viewpoint 451. As such, the GPU processing or rendering the image or surface 400 including area 402 can utilize multiple viewpoints or multi-view rendering.

As indicated herein, GPUs or graphics processor units can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

In some aspects of graphics processing, GPU hardware may be divided into multiple sections, e.g., hardware for geometry processing and hardware for pixel processing. Scalable GPU hardware may be desirable in order to meet different throughputs across various market segments. Also, in some aspects, scalable hardware for pixel processing may be designed in a variety of ways. For instance, a screen may be divided into different parts and multiple pixel processing hardware modules (i.e., slices) may work independently on different parts of the screen. By changing the number of pixel slices, a scalable throughput may be achieved for different tiers. However, designing scalable geometry processing hardware has an inherent challenge of evenly distributing the workload across independently working hardware modules (i.e., geometry slices).

There are a number of issues that may be encountered when designing scalable geometry processing hardware. For instance, the variable size of a drawcall (i.e., a work unit) and an adaptive workload expansion in the middle of the geometry pipeline are some issues that may occur when designing scalable geometry processing hardware. Workloads across different draw calls may vary, so tying each drawcall to a geometry slice may create uneven data downstream. Apart from this, an application program interface (API) may specify that a geometry pipeline may support adaptive workload expansion/reduction through different features, e.g., tessellation, geometry shading, and/or triangle culling.

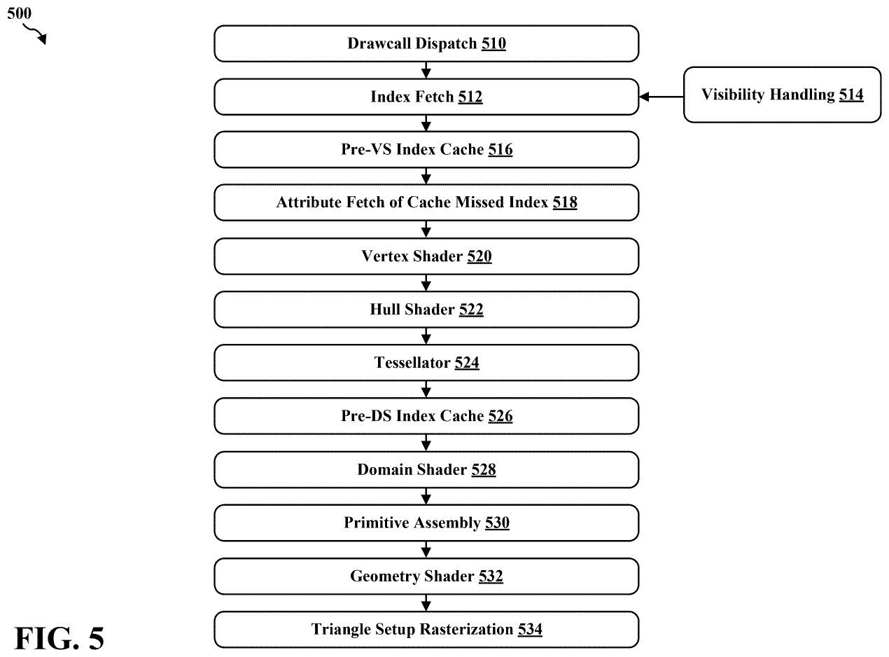

FIG. 5 is a diagram 500 illustrating an example geometry pipeline in a GPU. As depicted in FIG. 5, diagram 500 includes a drawcall dispatch 510, an index fetch 512, a visibility handling step 514, a pre-vertex shader index cache 516, an attribute fetch of a cache missed index 518, a vertex shader 520, a hull shader 522, a tessellator 524, a pre-domain shader index cache 526, a domain shader 528, a primitive assembly 530, a geometry shader 532, and a triangle setup rasterization 534. As shown in FIG. 5, after an index fetch 512, each primitive may be expanded to create multiple primitives, where an amplification factor may be determined during run-time. As such, sending primitives to different modules without considering an amplification factor may create an unequal workload in a downstream pipeline. Accordingly, this may prevent the achievement of an optimal throughput.

Another issue that may be encountered when designing scalable geometry processing hardware is visibility handling (e.g., tiled rendering) across multiple geometry slices. As indicated above, in tile-based rendering, the screen is divided into multiple bins, and a binning pass is used to generate a per-bin visibility stream (i.e., primitives that may be identified as visible in a bin). Also, the visibility stream may be used in multiple bin-rendering passes (e.g., dropping invisible primitives from processing) to render the whole screen. Because of different visibilities of primitives, the workload pattern in each bin-rendering pass may vary significantly from a binning pass. A workload distribution scheme may need to ensure that an even workload (including amplification) is distributed to each geometry slice (even when accounting for the potential disparity in visibility).

In some aspects, different types of GPU hardware may support different types of workload execution. Additionally, different types of workloads may take a different amount of processing time in various stages of the GPU pipeline. Also, these types of workloads may introduce inefficiency in GPU hardware utilization. In some aspects, scheduling algorithms in order to time-share the GPU hardware may sequence the workload to achieve the best utilization of GPU hardware. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

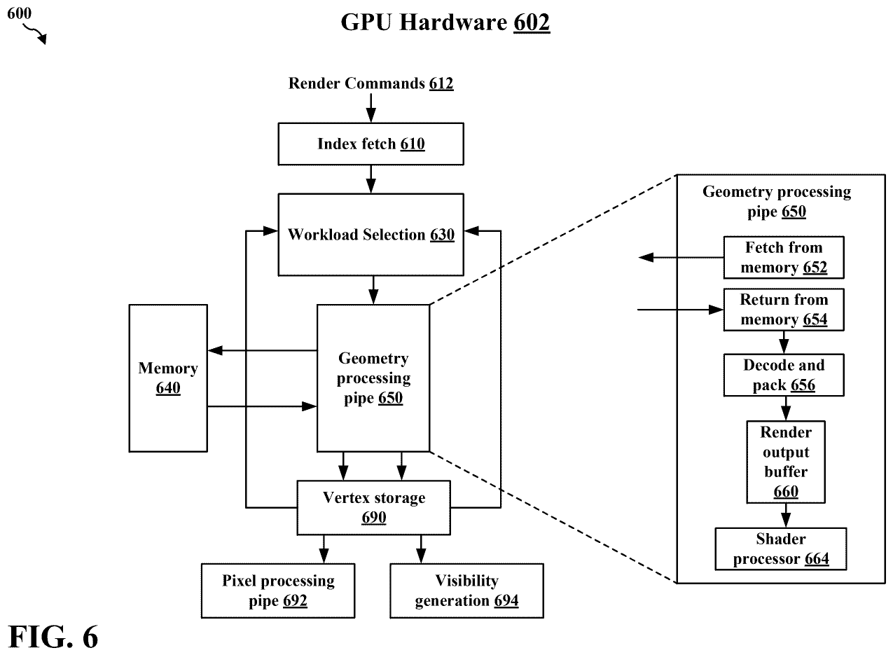

FIG. 6 illustrates diagram 600 including one example of GPU hardware. More specifically, diagram 600 depicts a time-shared GPU hardware for concurrent binning. As shown in FIG. 6, diagram 600 includes GPU hardware 602 including index fetch component 610, workload selection component 630, memory 640, geometry processing pipe 650, vertex storage component 690, pixel processing pipe 692, and visibility generation component 694. As shown in FIG. 6, render commands 612 may be input to index fetch component 610, which may be output to workload selection component 630. The workload selection component 630 may have a render/sort selection capability, as well as a certain granularity (e.g., a granularity for a group of N primitives). Also, the workload selection component 630 may be referred to as a workload selection switch component, switch component, workload selection component, or selection component. The “switch” may refers to a switch in the selection of render/sorting workloads. The output of workload selection component 630 may be sent to geometry processing pipe 650, which may communicate with memory 640. The geometry processing pipe 650 may include fetch from memory component 652, return from memory component 654, decode and pack component 656, render output buffer 660, and shader processor 664. Also, the output of geometry processing pipe 650 may be sent to vertex storage component 690, which may be sent to pixel processing pipe 692 and visibility generation component 694.

As shown in FIG. 6, geometry pipe hardware (e.g., geometry processing pipe 650) may be time shared between tile sorting and tile render workloads. Also, a scheduling algorithm (e.g., workload selection component 630) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 6, the workload selection component 630 may have a granularity of a group of N primitives. For instance, for concurrent binning, the workload distribution granularity may be a primitive batch (e.g., a set of N primitives).

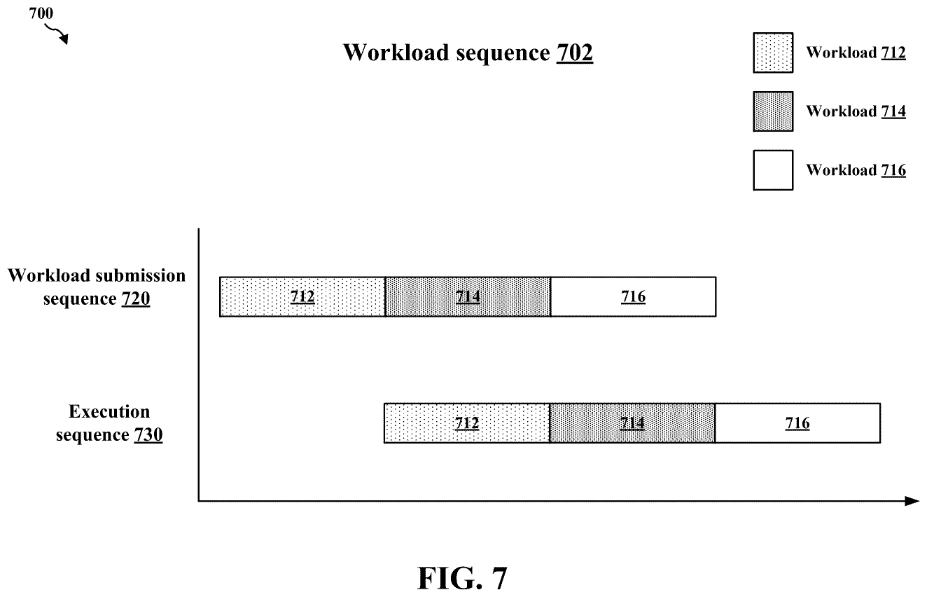

Certain types of workloads (e.g., sorting workloads) may face higher memory access latencies compared to other types of workloads (e.g., render workloads). For example, render workloads may be of higher priority than sorting workloads, which may face higher memory access latencies. In some aspects, if these types of workloads (e.g., sorting workloads) are executed in-order as per the scheduled workload sequence and granularity, there may be a reduction in hardware efficiency. For instance, if these types of workloads (e.g., sorting workloads) are executed in-order as per the scheduled workload sequence and granularity, a certain workload block (e.g., a head-of-line block) may occur, thus reducing the hardware efficiency. This type of scenario is shown in FIG. 7.

FIG. 7 illustrates diagram 700 including one example of a workload execution sequence. More specifically, diagram 700 depicts a workload execution sequence for a GPU (i.e., a scheduled execution order). As shown in FIG. 7, diagram 700 includes workload sequence 702 including workload 712, workload 714, workload 716, workload submission sequence 720, and execution sequence 730. FIG. 7 depicts a timeline of workload execution including workload submission sequence 720 and execution sequence 730. FIG. 7 illustrates that certain types of workloads (e.g., workload 712, workload 714, and workload 716) are executed in a certain order as per the scheduled workload sequence. As shown in FIG. 7, consider a workload submission sequence 720 (e.g., as determined by the workload selection component 630 in FIG. 6) to be workload 712, workload 714, and workload 716. Each of these workload may need to fetch data from memory (e.g., memory 640) and send it to shader processor (e.g., shader processor 664) for further processing. In some aspects, there may be a limit on how many requests can be made without processing the returned data (e.g., an OT limit). In some instances, some of the memory accesses for workload 714 may be granted before all accesses for workload 712, and some of the memory accesses for workload 716 may be granted before all accesses for workload 714.

In aspects of graphics processing, some graphics applications may render to a single target, i.e., a render target, one or more times. For instance, in graphics rendering, a frame buffer on a system memory may be updated multiple times. The frame buffer may be a portion of memory or random access memory (RAM) (e.g., containing a bitmap or storage) to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

As indicated herein, graphics processors (e.g., GPUs) may work in a number of different fashions (e.g., a single instruction, multiple data (SIMD) fashion). GPUs may process certain types of instructions that are associated with an operation (e.g., an SIMD operation). For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of 3D computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor may utilize one or more context states to perform various operations and calculations. For instance, a shader processor may be part of multiple shared cores for data processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock.

A symmetric multiprocessor (SM) may be single instruction multiple thread processor which has multiple shared cores at a GPU (e.g., shader processors) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization/pointer of coherence (PoS/PoC) may be point in the system-on-chip (SoC) post where every master in the system may see the same coherent copy of data.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

Some types of GPUs may include a number of different types of registers or memory, such as general purpose registers (GPRs). A GPR may be a register that stores both data and addresses. That is, the GPR may be a combined data/address register. A register may refer to a location that may be accessed by a processor. Additionally, a register may include a small amount of relatively quickly accessible storage. GPUs may include other types of memory, such as graphics memory (GMEM) or on-chip memory, which may store data or data buffers.

Modern GPUs may include a number of different types of GPRs, such as vector GPRs and scalar GPRs. Vector GPRs are fiber based GPRs, which are costly to GPU performance and memory (e.g., each fiber may have its own GPR). As indicated above, the term wave may refer to a set of threads or blocks that run concurrently on a GPU, where waves may include a number of fibers for executing instructions at the GPU. Vector GPRs may also limit a parallel wave number at a GPU. Scalar GPRs may be shared by all fibers in a wave, which may be cheaper to build/access, as well as more power efficient, than vector GPRs. For example, in a vector GPR, 1 wave of 64 fibers may correspond to 64 physical instances of the vector GPR using the GPU hardware. In a scalar GPR, there may be one GPR inside of the GPU hardware. That is, a GPU may include scalar GPRs and vector GPRs, where scalar GPRs may be more efficient than vector GPRs.

In graphics processing and computer graphics, a shader may be a computer program that calculates a level of light (e.g., light, darkness, and color) during the rendering of a scene. This process of rendering and shading a scene may be referred to as shading. Shaders may perform a variety of specialized functions in graphics processing, computer graphics, video post-processing, and general-purpose computing on graphics processors. A shader may be a program that is used to control the rendering effects of computer graphics. There may be a number of different types of shaders (e.g., vertex shaders, pixel shaders, and geometry shaders), which may handle a different aspect of the rendering process. Shaders may be used to produce lighting, shadows, textures, and other visual effects in video games, simulations, and other applications. A shader processor may utilize context states to perform various operations and calculations. That is, a shader processor may be part of multiple shared cores for data processing. Additionally, a shader processor may execute shader code (e.g., vertex shaders, fragment shaders, compute shaders, etc.).

Modern shaders may be complex, and it is important to understand the performance and execution of these shaders. Shaders may be constructed by a number of instructions (e.g., thousands of instructions). It may be important to obtain some information based on shader live execution in order to improve on the understanding of shader behavior. In contrast, traditional CPUs and digital signal processors (DSPs) may not include such shaders. In a CPU, an entire program may normally be too complex to use any execution graph to represent the program. For instance, CPU developers may have a better toolchain (i.e., a collection of software development tools that are used to build and develop software) to debug or tune performance. In a DSP, the program may target specialized problems and hotspots that are normally known at early stage. DSPs may also have decent toolchain (i.e., a collection of software development tools that are used to build and develop software) for solving this issue. So shader utilization is different at a CPU compared to other processors, such as a GPU or DSP.

A central processing unit (CPU) may refer to a primary processor within a computer. The electronic circuitry in a CPU may execute instructions of a computer program, such as arithmetic, logic, controlling, and input/output (I/O) operations. The role of the CPU within a computer may contrast with that of external components, such as main memory and I/O circuitry, and other processors, such as graphics processing units (GPUs). Some components of a CPU include an arithmetic logic unit (ALU) that performs arithmetic and logic operations, processor registers that supply operands to the ALU and store the results of ALU operations, and a control unit that orchestrates fetching (from memory), decoding, and execution of instructions, such as by directing the coordinated operations of the ALU, registers, and other components. A streaming mode compute unit (SMCU) may refer to a processing unit within a system designed to handle continuous data streams, thus allowing for high-speed data processing without interruption. An SMCU may be used in applications like real-time video analysis or live data feeds. For instance, an SMCU may be a compute unit that is optimized for processing data upon arrival, rather than waiting for large batches of data to accumulate. Unlike other compute units that process data in blocks, streaming mode compute units may process data as it arrives, thus enabling near-instantaneous analysis. Due to a focus on continuous data handling, streaming mode compute units may achieve relatively high data processing rates. Also, as minimizing processing delays is crucial for streaming applications, streaming mode compute units may be optimized for low latency operations. Some example applications for streaming mode compute units are live video streaming, such as object detection or facial recognition, as well as processing sensor data from Internet of Things (IoT) devices in real-time. A streaming mode compute unit (SMCU) may be an extension of a CPU. The SMCU may include several different components, such as a matrix execution unit (MXU) and a load store unit (LSU). The MXU and LSU may process instructions for the SMCU (e.g., vector instructions (VX), matrix instructions (MX), and move instructions (MU) instructions (i.e., instructions to move data between the vector and matrix units)).

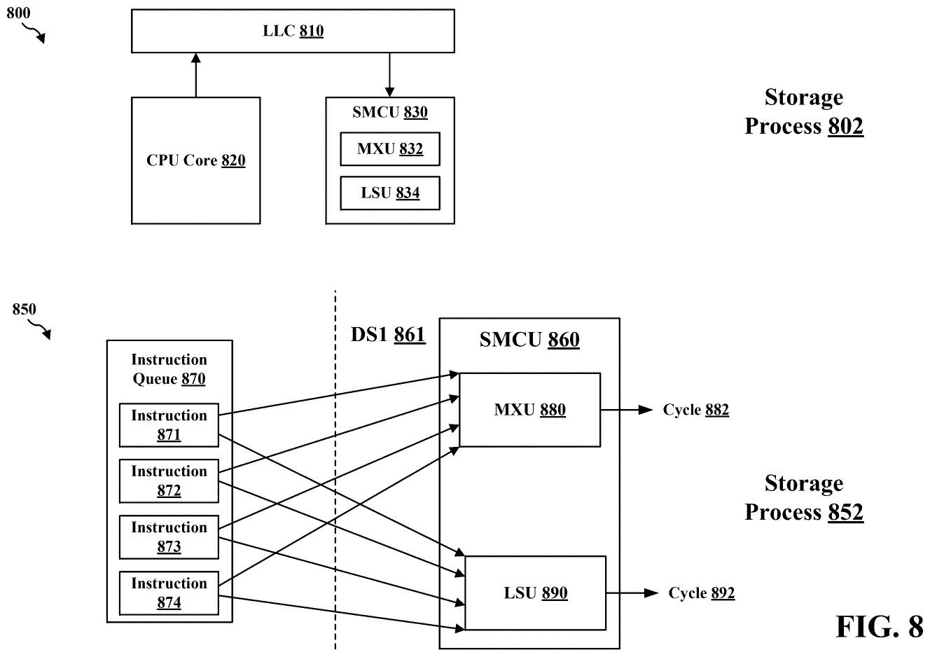

FIG. 8 illustrates diagrams including one example of a storage process. More specifically, diagram 800 depicts an example storage process 802 for a CPU. Diagram 800 includes last level cache (LLC) 810, CPU core 820, and SMCU 830 including MXU 832 and LSU 834. As shown in FIG. 8, diagram 800 illustrates that CPU core 820 can communicate data with the LLC 810 (e.g., CPU core 820 can transfer data to the LLC 810). Also, LLC 810 can communicate data with the SMCU 830 (e.g., LLC 810 can transfer data to the SMCU 830). Diagram 850 depicts example storage process 852 including a more detailed look at instructions (e.g., instruction queue 870) received at an SMCU (e.g., SMCU 860) including an MXU (e.g., MXU 880) and a LSU (e.g., LSU 890). As shown in diagram 850, instructions in an instruction queue 870 (e.g., instruction 871, instruction 872, instruction 873, and instruction 874) or buffer may be received by SMCU 860. For instance, instructions in instruction queue 870 (e.g., instruction 871, instruction 872, instruction 873, and instruction 874) may be sent to MXU 880. Also, instructions in instruction queue 870 (e.g., instruction 871, instruction 872, instruction 873, and instruction 874) may be sent to LSU 890. MXU 880 may process the instructions within a cycle (e.g., cycle 882). Further, LSU 890 may process the instructions within a cycle (e.g., cycle 892).

As depicted in FIG. 8, the LLC 810 (e.g., a shared cache) may be connected to the CPU core 820 and the SMCU 830. Whenever the CPU core 820 wants to execute certain types instructions, calculations, or workloads, it may utilize the SMCU 830, which may act as an extension of the CPU. After performing the calculations at the SMCU 830, the information may be sent back through the LLC 810. So the SMCU 830 may perform a backend execution of the CPU core 820. Also, the SMCU 830 may be an extension of the CPU (e.g., CPU core 820), along with other CPU extensions, such as a scalable matrix extension (SME). Instruction queue 870 may act as a buffer for the instructions, and then there are several pipeline stages where these instructions are decoded. Whenever the front end execution is done, there is a dispatch stage (e.g., DS1 861), which is gives these instructions to the main execution units (e.g., MXU 880 and LSU 890). The SMCU 830 may be a dedicated accelerator for the CPU, so it may not perform all the functions of a CPU (e.g., CPU core 820). While SMCU 830 may perform a few functions compared to the CPU, it may perform these functions faster than the CPU. The SMCU 830 may utilize the main execution units (e.g., MXU 880 and LSU 890) in order to perform these functions.

Some types of CPU extensions (e.g., SMCU or SME) may not be very low latency. For example, a load into the LSU may take a high amount of cycles (e.g., 60 to 70 cycles) to obtain data. Also, in some instances, the CPU may go straight into the reservation stations for certain executions. For some types of instructions, there may be small buffers that are mostly clear. A CPU may try to accept certain instructions and then eventually execute them at a certain pace. That is, a CPU may want to take a cluster of instructions and then execute them at a certain pace. And these instructions may need to be buffered. Additionally, a LSU (e.g., LSU 890) may have a high latency compared to a CPU core (e.g., CPU core 820). So a workload may need to be loaded (e.g., stored into a register) before the workload can be executed. The problem is that the loads may take a certain number of cycles (e.g., 60 to 70 cycles) in order to return the data. If a certain buffer (e.g., MXU buffer) fills up, it can no longer accept any instructions and the whole execution may stall. So because a high number of instructions may need to be accepted, the long latency may be an issue in order to not stop the execution at any point. That is, to be able to process a high number of instructions, the processing may need to be stopped at certain points, which creates issues. For instance, if any point loads are not being sent, there is going to be a time later where there is a gap in the execution of the data path instructions. Thus, a certain buffer size to be able to handle any gap in loads being sent and not have a corresponding gap in execution. Additionally, each execution unit in a CPU extension may have its own buffer. For example, a vector execution unit may have its own buffer for vector instructions (VX), a matrix execution unit may have its own buffer for matrix instructions (MX), and a move execution unit may have its own buffer for move instructions (MU). As such, there may be a large number of buffers for these execution units, which may cause execution gaps if the buffer size does not correspond to the amount of loads being sent. That is, a large amount of buffers may result in a worsening of timing for execution of data workloads.

Typical high performance CPU implementation has each reservation station bound to one specific type of instruction, and some dispatch buffers may be needed to decouple the reservation stations with the front end renaming logic. Each dispatch buffer may also hold one specific type of instruction. This allows for dispatch buffer content to be written to corresponding reservation station in as few as one cycle. However, such implementation may need careful sizing of each dispatch buffer considering the expected instruction sequences, and may be suboptimal for specific workloads. In the case of an accelerator design to execute SME instructions, allowing for large out-of-order window with the combined size of dispatch buffer and reservation station is important. However, the latency of dispatch buffer binding to a reservation station is less important, as the main target is a high instruction throughput. Also, having large reservation stations may pose physical design challenges when targeting higher frequencies. Based on the above, it may be beneficial to optimize or improve the amount of buffers at a CPU. Indeed, it may be beneficial to reduce the amount of buffers at a CPU, which may add memory and slow down the CPU. That is, it may be beneficial to utilize a large, shared dispatch buffer to reduce the amount of buffers. For instance, it may be beneficial to have a single, large buffer to be able to handle any gap in loads being sent and not have a corresponding gap in execution.

Aspects of the present disclosure may optimize or improve the amount of buffers at a CPU. For instance, aspects presented herein may reduce the amount of buffers at a CPU, in order to reduce the amount of memory and increase the processing speed of the CPU. That is, aspects presented herein may utilize a large, shared buffer to reduce the amount of buffers at a CPU. Indeed, aspects presented herein may utilize a single, large buffer (e.g., a large dispatch buffer) to be able to handle any gap in loads being sent and not experience a corresponding gap in execution. A large, shared dispatch buffer may bind to all smaller reservation stations, thus achieving a target buffer size with a minimum area overhead. Aspects presented herein may also allow the buffer design to have smaller size for each reservation station while still allowing for a large out-of-order window for all instruction types with any instruction sequences. This is beneficial to keep the area cost down at the CPU, but also helpful when pushing for a higher frequency physical design. Aspects presented herein may also share a data entry storage across multiple data reservation stations via a linked list (i.e., a linear collection of data elements whose order is not given by their physical placement in memory), rather than storing it in a buffer. So aspects presented herein may utilize multiple reservation stations per a single buffer. By adding multiple reservation stations for a single buffer, aspects presented herein may optimize the amount of buffers, which may reduce the amount of memory and increase the processing speed of the CPU. In turn, this may optimize or improve the overall performance of a CPU.

Aspects presented herein (e.g., a CPU) may obtain a set of instructions for data storage, where the set of instructions is associated with the data processing. Aspects presented herein (e.g., a CPU) may also configure a set of reservation stations for storage of the set of instructions in a buffer. Aspects presented herein (e.g., a CPU) may also store each of the set of instructions in a buffer, where the buffer is associated with a set of reservation stations. Additionally, aspects presented herein (e.g., a CPU) may determine at least one of a first available reservation station of the set of reservation stations or a corresponding reservation station of the set of reservation stations for each of the set of instructions. Aspects presented herein (e.g., a CPU) may also assign each of the set of instructions to one of the set of reservation stations based on storage of each of the set of instructions in the buffer. Assigning each of the set of instructions to one of the set of reservation stations may comprise assigning, via a linked list, each of the set of instructions to one of the set of reservation stations. Also, assigning each of the set of instructions to one of the set of reservation stations may comprise mapping each of the set of instructions to the corresponding reservation station of the set of reservation stations. Assigning each of the set of instructions to one of the set of reservation stations may also comprise assigning each of the set of instructions to the first available reservation station of the set of reservation stations.

Moreover, aspects presented herein (e.g., a CPU) may output an indication to transfer each of the set of instructions from the buffer to one of the set of reservation stations. Aspects presented herein (e.g., a CPU) may also remove, based on the indication, each of the set of instructions from the buffer for transfer to one of the set of reservation stations. Also, aspects presented herein (e.g., a CPU) may send, from the buffer based on the removal, each of the set of instructions to one of the set of reservation stations. The set of instructions may include at least one of: a set of vector instructions (VX), a set of matrix instructions (MX), or a set of move instructions (MU). The buffer may be at least one of a single data buffer, a shared data buffer, or a single shared data buffer, and the set of instructions may be a plurality of data instructions. Aspects presented herein (e.g., a CPU) may also output an indication of assignment of each of the set of instructions to one of the set of reservation stations.

Aspects presented herein may share the data entry storage for a CPU across a link list (i.e., a linear collection of data elements whose order is not given by their physical placement in memory). So aspects herein may share the data storage across all the reservation stations at a CPU via a linked list. That is, sharing the data storage across all the reservation stations may be possible via a link list. In some aspects, instead of utilizing multiple, separate buffers, aspects herein may utilize a buffer that is a link list, rather than a simple queue. The manner in which the buffer is written and allocated into is as through there is one buffer with multiple entries (e.g., 128 entries). So aspects herein may allocate from a dispatch stage (DS) (e.g., the stage when instructions go from the front of the machine and get dispatched to other execution units), such as a DS1 stage, into this buffer and aspects may allocate up to a certain amount of instructions (e.g., three instructions). Also, the entries in the buffer may be numbered, so each entry may contain the payload itself. Also, each entry in the buffer may contain a pointer, which is a pointer to the next entry in the list.

Additionally, aspects herein may implement a certain amount of linked lists (e.g., three linked lists), each of which may include a storage portion and a pointer. And aspects herein may perform an implementation of the multiple linked lists. That is, aspects herein may share the storage across multiple linked lists (e.g., three linked lists). So each single execution unit in the CPU may have a pointer for the last entry and the first entry. An execution unit may have a head pointer and a tail pointer in the buffer. So each entry in the buffer may store the pointer to the tail of the queue. That is, the last head pointer of this entry is going to become the new tail pointer. Also, this buffer may be traversed as if it is a link list.

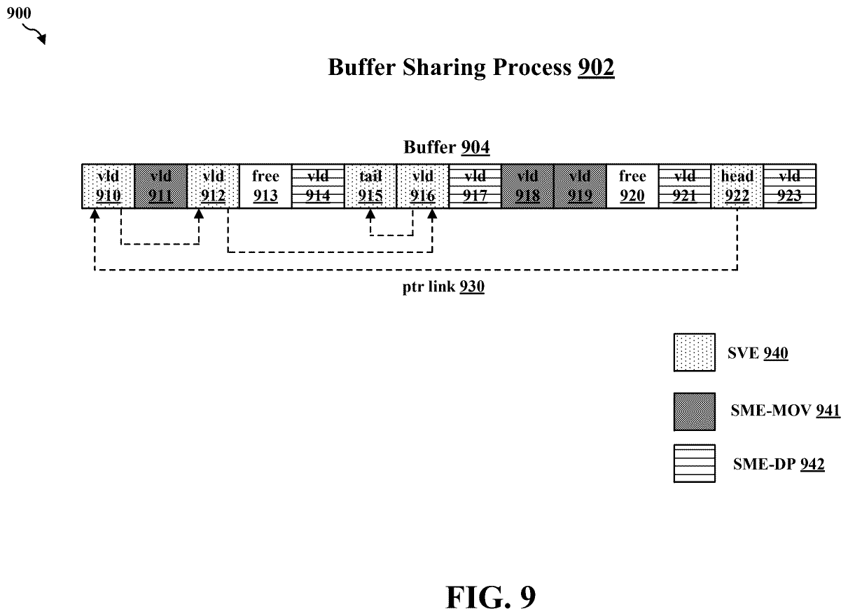

FIG. 9 illustrates diagrams including one example of a buffer sharing process. More specifically, diagram 900 depicts an example buffer sharing process 902 for a buffer 904 at a CPU. Diagram 900 includes buffer 904 (e.g., a dispatch buffer (DSB)), a number of valid (vld) entries (e.g., vld 910, vld 911, vld 912, vld 914, vld 916, vld 917, vld 918, vld 919, vld 921, and vld 923), a number of free entries (e.g., free 913, free 920), a tail pointer entry (e.g., tail 915), a head pointer entry (e.g., head 922), and a pointer (ptr) link 930. As shown in FIG. 9, diagram 900 illustrates that each of the entries in buffer 904 correspond to a scalable vector extension (SVE) (e.g., SVE 940, as indicated with lightly-dotted entries), a scalable matrix extension (SME) move instruction (SME-MOV) (e.g., SME-MOV 941, as indicated with darkly-dotted entries), and SME dispatch (SME-DP) (e.g., SME-DP 942, as indicated with horizontally-lined entries). As shown in FIG. 9, vld 910 entry points to vld 912 entry, vld 912 entry points to vld 916 entry, vld 916 entry points to tail 915 entry, and head 922 entry points to vld 910 entry via ptr link 930.

As shown in FIG. 9, the dispatch buffer (DSB) (e.g., buffer 904) may be a free listed queue of configurable length (e.g., 48-64 entries) that may add a dispatch stage (DS) (e.g., DS2) between a random access memory (RAM) expansion unit (REU) and an MXU. The DSB storage may be shared by all micro operation (uOP) types of instructions (e.g., low-level instructions) and there may be no per-type minimums for instructions. Micro operations (uOPs) may be kept separate by implementing a number of linked lists (e.g., three linked lists), such as one linked list per uOP type. By using separate linked lists, ordering may be preserved between uOPs of the same type, but not between uOPs of different types. Additionally, each linked list may dispatch to its own reservation station. For example, SME move instruction (SME-MOV) uOPs may dispatch into the move instruction (MOV) reservation station (RS) (MOV-RS). SME dispatch instruction (SME-DP) uOPs may dispatch into the matrix extension (MX) reservation station (RS) (MX-RS). Also, SVE uOPs may dispatch into the vector extension (VX) reservation station (RS) (VX-RS). In some aspects, keeping the linked lists and reservation stations separate may increase the out-of-order (OoO) window between instructions of different types, while also keeping the reservation station sizes manageable. This may be a key to exploiting certain benefits (e.g., the benefit of ZA renaming (i.e., ZA renaming may refer to the concept of assigning a different ZA array (zaTag) to a ZA producers of a same thread if the last operation to the ZA array was to zero it out completely)).

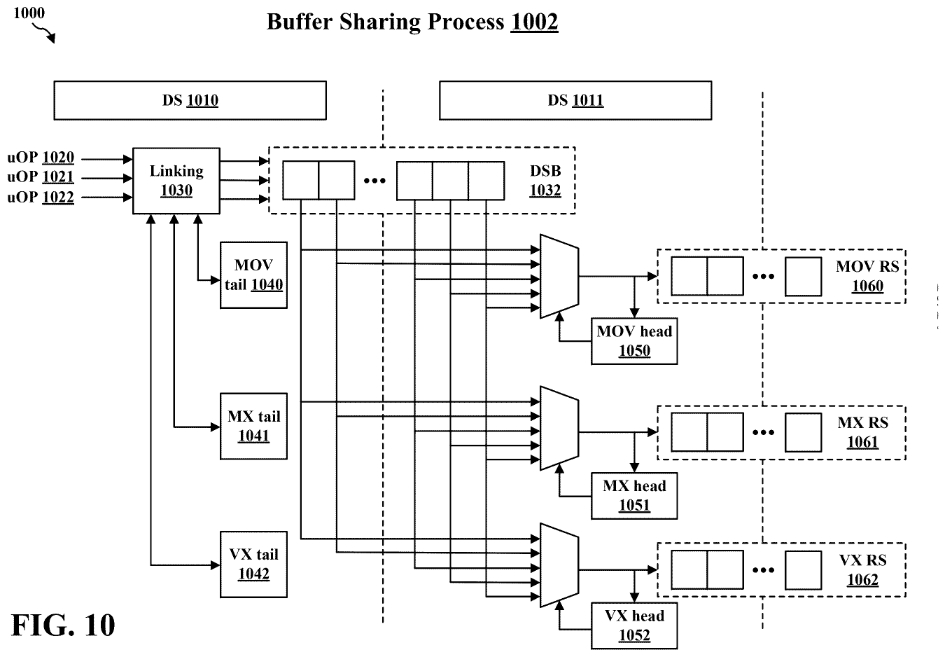

FIG. 10 illustrates diagrams including one example of a buffer sharing process. More specifically, diagram 1000 depicts an example buffer sharing process 1002 for a dispatch buffer (e.g., a DSB 1032 at a CPU). Diagram 1000 includes dispatch stages (DSs) (e.g., DS 1010 and DS 1011), a number of micro operations (uOPs) (e.g., uOP 1020, uOP 1021, uOP 1022), a linking stage 1030, DSB 1032, MOV tail pointer 1040, MX tail pointer 1041, VX tail pointer 1042, MOV head pointer 1050, MX head pointer 1051, VX head pointer 1052, MOV RS 1060, MX RS 1061, and VX RS 1062. As shown in FIG. 10, diagram 1000 illustrates the use of a dispatch buffer (DSB) via a linked list. The micro operations (uOPs) (e.g., uOP 1020, uOP 1021, uOP 1022) may be kept separate by implementing a number of linked lists (e.g., three linked lists), which amounts to one linked list per uOP type. By using separate linked lists, ordering may be preserved between uOPs of the same type, but not between uOPs of different types.

As shown in FIG. 10, DS 1010 may be a first level between REU and MXU. Also, up to three uOPs per cycle (e.g., uOP 1020, uOP 1021, uOP 1022) may be allocated into the DSB 1032. The DSB 1032 may be banked, and each bank may be free listed. Further, each bank may allocate up to one uOP per cycle (e.g., uOP 1020, uOP 1021, or uOP 1022). As further illustrated in FIG. 10, the number of uOPs (e.g., uOP 1020, uOP 1021, uOP 1022) dispatched per cycle may be limited by the number of DSB banks (e.g., banks in DSB 1032) with free entries. Moreover, the ordering between uOPs (e.g., uOP 1020, uOP 1021, uOP 1022) may be maintained using linked lists. That is, each uOP (e.g., uOP 1020, uOP 1021, uOP 1022) in the DSB 1032 may hold a pointer to the next uOP (e.g., younger uOP) in the linked list. Head and tail pointers may be maintained per linked list. Additionally, there may be a certain number of linked lists (e.g., three linked lists), which may amount to one linked list per instruction type. SVE uOP instruction types may have a linked list, which may include all instructions that use the SVE functional units and do not access the ZA accumulator, either to read it or write it. SME MOV uOP instruction types may also have a linked list, which may include all SME uOPs that move data from a ZRF to a ZA, and from a ZA to a ZRF. Moreover, SME uOPs instruction types that are not of type SME MOV uOP may have a linked list. The uOP type may not affect the number of uOPs that can be dispatched in each cycle.

As shown in FIG. 10, DS 1011 may include reservation station per uOP type (and per linked list). If the reservation station can accept the uOP, the head of the linked list may be popped and dequeued from the DSB 1032. Also, if the reservation station can accept the uOP, the register field valid (RFV) may be checked for all uOP sources. Further, if the reservation station can accept the uOP, dispatch CAMs may be performed. Additionally, if the reservation station can accept the uOP, the uOP may be sent to the reservation station. In some aspects, compared to a single stage dispatch, the two level scheme in FIG. 10, may allow to maintain the same number of instructions in flight (utilized by the LSU), while reducing the MXU reservation station sizes. The two main advantages are scheduling and power reduction. Regarding the scheduling advantage, the reservation station sizes can be picked to suit design conditions. In this case a smaller reservation station may use an age matrix to support OoO scheduling. Regarding the power reduction advantage, entries in the DSB are inactive (no lookups or source wake ups). The DSB may be sized to allow the LSU to run ahead with loads and stores without having to perform source wakeups for all uOPs in flight. As depicted in FIGS. 9 and 10, a valid (vld) field name may refer to an entry that is valid. Thread ID may refer to the ID of the thread for the uOP. RNUM may refer to a number of bits. Also, opcode may refer to the original instruction opcode, unaltered. Further, seqNum may refer to the sequential number for u-coded instructions. Src0 Tag may refer to the tag for source 0 (e.g., source 0 can be Z type, and Source 0 may be valid for MX, and either valid or invalid for VX and MV). Src1 Tag may refer to the tag for source 1 (e.g., source 1 may be either Z or P type for VX, Z type for MX, and P type for MV. Source 1 may be either valid or invalid for MX, MV and VX). Src2 Tag may refer to the tag for source 2 (e.g., source 2 may be either Z or P type for VX, and P type for MX. Source 2 may be valid for MX, either valid or invalid for VX, and invalid for MV). Src3 Tag may refer to the tag for source 3 (e.g., source 3 may be P type. Source 3 may be valid for MX, and invalid for VX and MV). Dst 0 Tag may refer to the tag for destination 0 (e.g., Dst 0 may be Z type for MV, and either Z type or P type for VX. Dst0 may be invalid for MX, and either valid or invalid for VX and MV). ZA Tag may refer to the tag for the ZA tile. ZA count may be used for ordering SME uOPs. Also, the number of bits per field may be indicative and depend on configuration. Further, whether the sources and destinations are valid depends on the opcode, which may be decoded in DS2. Moreover, there may be no need to store the valid bits in the DSB.

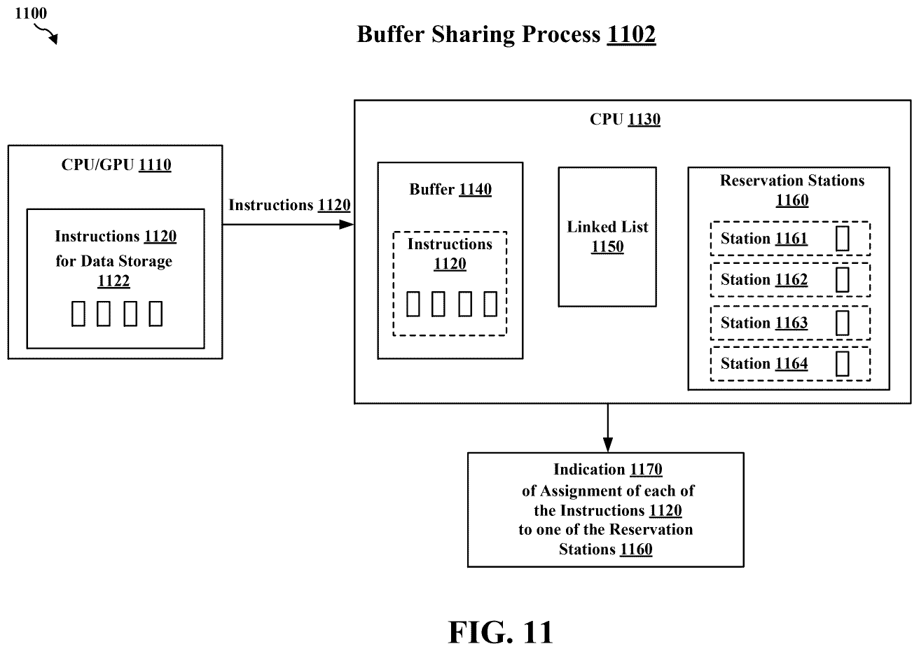

FIG. 11 illustrates diagram 1100 including one example of a buffer sharing process. More specifically, diagram 1100 depicts an example buffer sharing process 1102 for a CPU. As shown in FIG. 11, diagram 1100 includes CPU/GPU 1110, instructions 1120, data storage 1122, CPU 1130, buffer 1140, linked list 1150, reservation stations 1160 (e.g., station 1161, station 1162, station 1163, and station 1164), and indication 1170. As shown in FIG. 11, CPU 1130 may obtain a set of instructions (e.g., instructions 1120) for data storage, where the set of instructions is associated with data processing. CPU 1130 may also configure a set of reservation stations 1160 (e.g., station 1161, station 1162, station 1163, and station 1164) for storage of the set of instructions (e.g., instructions 1120) in a buffer (e.g., buffer 1140). CPU 1130 may also store each of the set of instructions (e.g., instructions 1120) in a buffer (e.g., buffer 1140), where the buffer is associated with a set of reservation stations 1160. Additionally, CPU 1130 may determine at least one of a first available reservation station (e.g., station 1161) of the set of reservation stations 1160 or a corresponding reservation station (e.g., station 1162) of the set of reservation stations 1160 for each of the set of instructions 1120. CPU 1130 may also assign each of the set of instructions 1120 to one of the set of reservation stations 1160 based on storage of each of the set of instructions 1120 in the buffer 1140. Assigning each of the set of instructions 1120 to one of the set of reservation stations 1160 may comprise assigning, via a linked list 1150, each of the set of instructions 1120 to one of the set of reservation stations 1160. Also, assigning each of the set of instructions 1120 to one of the set of reservation stations 1160 may comprise mapping each of the set of instructions 1120 to the corresponding reservation station (e.g., station 1162) of the set of reservation stations 1160. Assigning each of the set of instructions 1120 to one of the set of reservation stations 1160 may also comprise assigning each of the set of instructions 1120 to the first available reservation station (e.g., station 1161) of the set of reservation stations 1160.

Moreover, CPU 1130 may output an indication to transfer each of the set of instructions 1120 from the buffer 1140 to one of the set of reservation stations 1160. CPU 1130 may also remove, based on the indication, each of the set of instructions 1120 from the buffer 1140 for transfer to one of the set of reservation stations 1160. Also, CPU 1130 may send, from the buffer 1140 based on the removal, each of the set of instructions 1120 to one of the set of reservation stations 1160. The set of instructions 1120 may include at least one of: a set of vector instructions (VX), a set of matrix instructions (MX), or a set of move instructions (MU). The buffer 1140 may be at least one of a single data buffer, a shared data buffer, or a single shared data buffer, and the set of instructions 1120 may be a plurality of data instructions. CPU 1130 may also output an indication 1170 of assignment of each of the set of instructions 1120 to one of the set of reservation stations 1160.

Aspects of the present disclosure may include a number of benefits or advantages. For instance, aspects of the present disclosure may optimize or improve the amount of buffers at a CPU. Aspects presented herein may reduce the amount of buffers at a CPU, in order to reduce the amount of memory and increase the processing speed of the CPU. That is, aspects presented herein may utilize a large, shared buffer to reduce the amount of buffers at a CPU. Indeed, aspects presented herein may utilize a single, large buffer (e.g., a large dispatch buffer) to be able to handle any gap in loads being sent and not experience a corresponding gap in execution. A large, shared dispatch buffer may bind to all smaller reservation stations, thus achieving a target buffer size with a minimum area overhead. Aspects presented herein may also allow the buffer design to have smaller size for each reservation station while still allowing for a large out-of-order window for all instruction types with any instruction sequences. This is beneficial to keep the area cost down at the CPU, but also helpful when pushing for a higher frequency physical design. Aspects presented herein may also share a data entry storage across multiple data reservation stations via a linked list (i.e., a linear collection of data elements whose order is not given by their physical placement in memory), rather than storing it in a buffer. So aspects presented herein may utilize multiple reservation stations per a single buffer. By adding multiple reservation stations for a single buffer, aspects presented herein may optimize the amount of buffers, which may reduce the amount of memory and increase the processing speed of the CPU. In turn, this may optimize or improve the overall performance of a CPU.

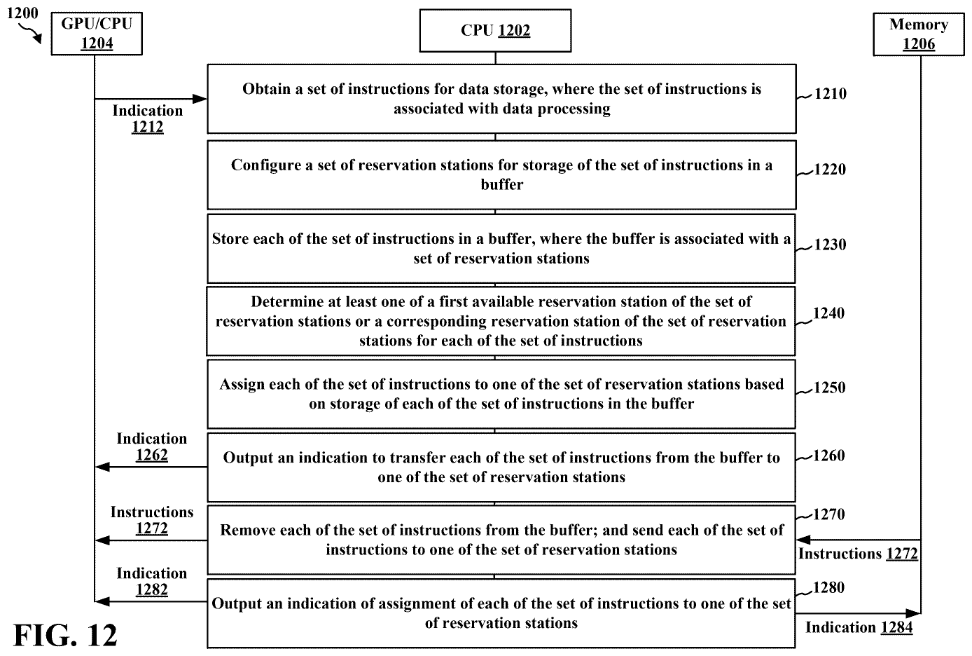

FIG. 12 is a communication flow diagram 1200 of data processing in accordance with one or more techniques of this disclosure. As shown in FIG. 12, diagram 1200 includes example communications between CPU 1202 (e.g., a CPU, a streaming mode compute unit (SMCU), a compiler, a CPU component, another central processor, a GPU, a GPU component, or another graphics processor), GPU/CPU 1204 (e.g., a GPU, a GPU component, another graphics processor, a CPU, a streaming mode compute unit (SMCU), a compiler, a CPU component, or another central processor), and memory 1206 (e.g., a memory, a cache, a system memory, a graphics memory, a memory or cache at a CPU, or a memory or cache at a GPU), in accordance with one or more techniques of this disclosure.

At 1210, CPU 1202 may obtain a set of instructions for data storage, where the set of instructions is associated with the data processing. For example, CPU 1202 may obtain indication 1212 from GPU/CPU 1204. The set of instructions may include at least one of: a set of vector instructions (VX), a set of matrix instructions (MX), or a set of move instructions (MU).

At 1220, CPU 1202 may configure a set of reservation stations for storage of the set of instructions in a buffer. In some aspects, configuring the set of reservation stations for the storage of the set of instructions in the buffer may comprise: mapping the set of reservation stations for the storage of the set of instructions in the buffer.

At 1230, CPU 1202 may store each of the set of instructions in a buffer, where the buffer is associated with a set of reservation stations. The buffer may be at least one of a single data buffer, a shared data buffer, or a single shared data buffer, and the set of instructions may be a plurality of data instructions. In some aspects, storing each of the set of instructions in the buffer may comprise: storing each of the set of instructions in the buffer at a central processing unit (CPU) or a streaming mode compute unit (SMCU).

At 1240, CPU 1202 may determine at least one of a first available reservation station of the set of reservation stations or a corresponding reservation station of the set of reservation stations for each of the set of instructions. In some aspects, assigning each of the set of instructions to one of the set of reservation stations may comprise: mapping each of the set of instructions to the corresponding reservation station of the set of reservation stations. Also, assigning each of the set of instructions to one of the set of reservation stations may comprise: assigning each of the set of instructions to the first available reservation station of the set of reservation stations.

At 1250, CPU 1202 may assign each of the set of instructions to one of the set of reservation stations based on storage of each of the set of instructions in the buffer. In some aspects, assigning each of the set of instructions to one of the set of reservation stations may comprise: assigning, via a linked list, each of the set of instructions to one of the set of reservation stations. The linked list may include a linear collection of a set of data elements, where a current data element in the set of data elements holds a data pointer for a subsequent data element in the set of data elements. Also, assigning, via the linked list, each of the set of instructions to one of the set of reservation stations may comprise: mapping, via the linked list, each of the set of instructions to one of the set of reservation stations. In some aspects, assigning each of the set of instructions to one of the set of reservation stations may comprise: assigning, via a central processing unit (CPU) or a streaming mode compute unit (SMCU), each of the set of instructions to one of the set of reservation stations.

At 1260, CPU 1202 may output an indication to transfer each of the set of instructions from the buffer to one of the set of reservation stations. For example, CPU 1202 may output indication 1262 to GPU/CPU 1204.

At 1270, CPU 1202 may remove, based on the indication, each of the set of instructions from the buffer for transfer to one of the set of reservation stations. For example, CPU 1202 may remove instructions 1272 from memory 1206. In some aspects, removing each of the set of instructions from the buffer may comprise: dequeuing, from the buffer, each of the set of instructions for the transfer to one of the set of reservation stations. Also, at 1270, CPU 1202 may send, from the buffer based on the removal, each of the set of instructions to one of the set of reservation stations. For example, CPU 1202 may send instructions 1272 to GPU/CPU 1204. In some instances, sending each of the set of instructions to one of the set of reservation stations may comprise: enqueuing, in one of the set of reservation stations, each of the set of instructions.

At 1280, CPU 1202 may output an indication of assignment of each of the set of instructions to one of the set of reservation stations. In some aspects, outputting the indication of the assignment of each of the set of instructions to one of the set of reservation stations may comprise transmitting the indication of the assignment of each of the set of instructions to one of the set of reservation stations. For example, CPU 1202 may transmit indication 1282 to GPU/CPU 1204. Also, outputting the indication of the assignment of each of the set of instructions to one of the set of reservation stations may comprise storing the indication of the assignment of each of the set of instructions to one of the set of reservation stations. For example, CPU 1202 may store indication 1284 in memory 1206.

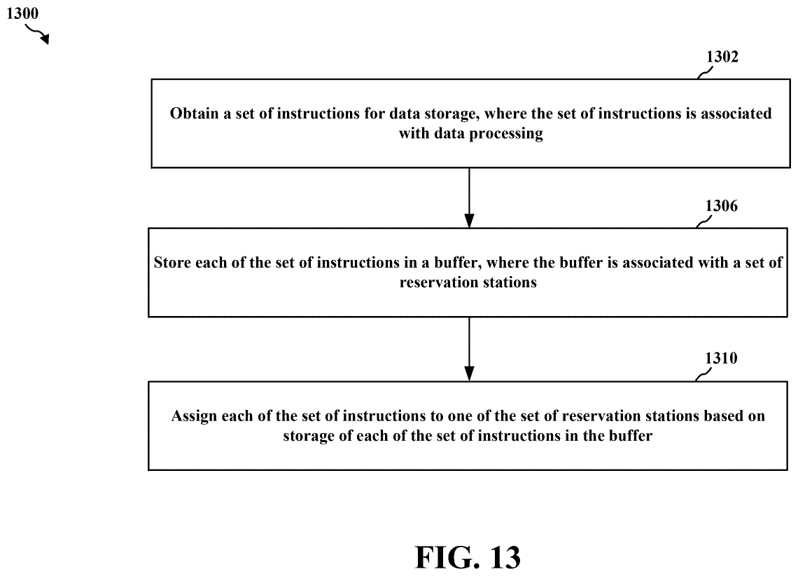

FIG. 13 is a flowchart 1300 of an example method of data processing in accordance with one or more techniques of this disclosure. The method may be performed by a CPU (e.g., a CPU, a streaming mode compute unit (SMCU), a compiler, a CPU component, another central processor, a GPU, a GPU component, or another graphics processor), a GPU (e.g., a GPU, a compiler, a GPU component, another graphics processor, a CPU, a streaming mode compute unit (SMCU), a CPU component, or another central processor), a display driver integrated circuit (DDIC), an apparatus for data processing, a wireless communication device, and/or any apparatus that may perform data processing as used in connection with the examples of FIGS. 1-12.

At 1302, the CPU may obtain a set of instructions for data storage, where the set of instructions is associated with the data processing, as described in connection with the examples in FIGS. 1-12. For example, as described in 1210 of FIG. 12, CPU 1202 may obtain a set of instructions for data storage, where the set of instructions is associated with the data processing. Further, step 1302 may be performed by processing unit 120 in FIG. 1. For example, CPU 1202 may obtain indication 1212 from GPU/CPU 1204. The set of instructions may include at least one of: a set of vector instructions (VX), a set of matrix instructions (MX), or a set of move instructions (MU).

At 1306, the CPU may store each of the set of instructions in a buffer, where the buffer is associated with a set of reservation stations, as described in connection with the examples in FIGS. 1-12. For example, as described in 1230 of FIG. 12, CPU 1202 may store each of the set of instructions in a buffer, where the buffer is associated with a set of reservation stations. Further, step 1306 may be performed by processing unit 120 in FIG. 1. The buffer may be at least one of a single data buffer, a shared data buffer, or a single shared data buffer, and the set of instructions may be a plurality of data instructions. In some aspects, storing each of the set of instructions in the buffer may comprise: storing each of the set of instructions in the buffer at a central processing unit (CPU) or a streaming mode compute unit (SMCU).

At 1310, the CPU may assign each of the set of instructions to one of the set of reservation stations based on storage of each of the set of instructions in the buffer, as described in connection with the examples in FIGS. 1-12. For example, as described in 1250 of FIG. 12, CPU 1202 may assign each of the set of instructions to one of the set of reservation stations based on storage of each of the set of instructions in the buffer. Further, step 1310 may be performed by processing unit 120 in FIG. 1. In some aspects, assigning each of the set of instructions to one of the set of reservation stations may comprise: assigning, via a linked list, each of the set of instructions to one of the set of reservation stations. The linked list may include a linear collection of a set of data elements, where a current data element in the set of data elements holds a data pointer for a subsequent data element in the set of data elements. Also, assigning, via the linked list, each of the set of instructions to one of the set of reservation stations may comprise: mapping, via the linked list, each of the set of instructions to one of the set of reservation stations. In some aspects, assigning each of the set of instructions to one of the set of reservation stations may comprise: assigning, via a central processing unit (CPU) or a streaming mode compute unit (SMCU), each of the set of instructions to one of the set of reservation stations.

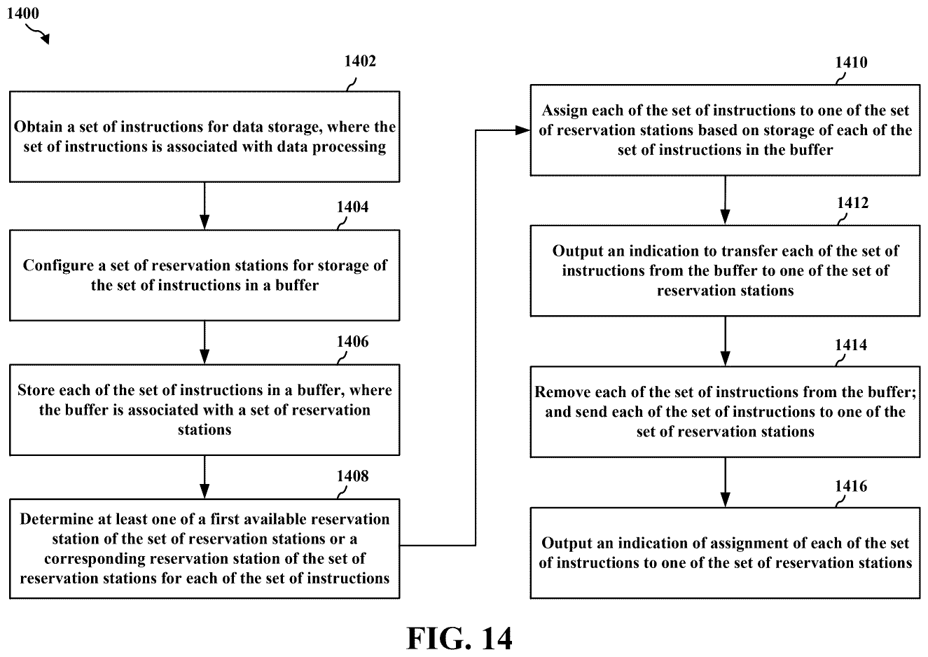

FIG. 14 is a flowchart 1400 of an example method of data processing in accordance with one or more techniques of this disclosure. The method may be performed by a CPU (e.g., a CPU, a streaming mode compute unit (SMCU), a compiler, a CPU component, another central processor, a GPU, a GPU component, or another graphics processor), a GPU (e.g., a GPU, a compiler, a GPU component, another graphics processor, a CPU, a streaming mode compute unit (SMCU), a CPU component, or another central processor), a display driver integrated circuit (DDIC), an apparatus for data processing, a wireless communication device, and/or any apparatus that may perform data processing as used in connection with the examples of FIGS. 1-12.

At 1402, the CPU may obtain a set of instructions for data storage, where the set of instructions is associated with the data processing, as described in connection with the examples in FIGS. 1-12. For example, as described in 1210 of FIG. 12, CPU 1202 may obtain a set of instructions for data storage, where the set of instructions is associated with the data processing. Further, step 1402 may be performed by processing unit 120 in FIG. 1. For example, CPU 1202 may obtain indication 1212 from GPU/CPU 1204. The set of instructions may include at least one of: a set of vector instructions (VX), a set of matrix instructions (MX), or a set of move instructions (MU).

At 1404, the CPU may configure a set of reservation stations for storage of the set of instructions in a buffer, as described in connection with the examples in FIGS. 1-12. For example, as described in 1220 of FIG. 12, CPU 1202 may configure a set of reservation stations for storage of the set of instructions in a buffer. Further, step 1404 may be performed by processing unit 120 in FIG. 1. In some aspects, configuring the set of reservation stations for the storage of the set of instructions in the buffer may comprise: mapping the set of reservation stations for the storage of the set of instructions in the buffer.

At 1406, the CPU may store each of the set of instructions in a buffer, where the buffer is associated with a set of reservation stations, as described in connection with the examples in FIGS. 1-12. For example, as described in 1230 of FIG. 12, CPU 1202 may store each of the set of instructions in a buffer, where the buffer is associated with a set of reservation stations. Further, step 1406 may be performed by processing unit 120 in FIG. 1. The buffer may be at least one of a single data buffer, a shared data buffer, or a single shared data buffer, and the set of instructions may be a plurality of data instructions. In some aspects, storing each of the set of instructions in the buffer may comprise: storing each of the set of instructions in the buffer at a central processing unit (CPU) or a streaming mode compute unit (SMCU).

At 1408, the CPU may determine at least one of a first available reservation station of the set of reservation stations or a corresponding reservation station of the set of reservation stations for each of the set of instructions, as described in connection with the examples in FIGS. 1-12. For example, as described in 1240 of FIG. 12, CPU 1202 may determine at least one of a first available reservation station of the set of reservation stations or a corresponding reservation station of the set of reservation stations for each of the set of instructions. Further, step 1408 may be performed by processing unit 120 in FIG. 1. In some aspects, assigning each of the set of instructions to one of the set of reservation stations may comprise: mapping each of the set of instructions to the corresponding reservation station of the set of reservation stations. Also, assigning each of the set of instructions to one of the set of reservation stations may comprise: assigning each of the set of instructions to the first available reservation station of the set of reservation stations.

At 1410, the CPU may assign each of the set of instructions to one of the set of reservation stations based on storage of each of the set of instructions in the buffer, as described in connection with the examples in FIGS. 1-12. For example, as described in 1250 of FIG. 12, CPU 1202 may assign each of the set of instructions to one of the set of reservation stations based on storage of each of the set of instructions in the buffer. Further, step 1410 may be performed by processing unit 120 in FIG. 1. In some aspects, assigning each of the set of instructions to one of the set of reservation stations may comprise: assigning, via a linked list, each of the set of instructions to one of the set of reservation stations. The linked list may include a linear collection of a set of data elements, where a current data element in the set of data elements holds a data pointer for a subsequent data element in the set of data elements. Also, assigning, via the linked list, each of the set of instructions to one of the set of reservation stations may comprise: mapping, via the linked list, each of the set of instructions to one of the set of reservation stations. In some aspects, assigning each of the set of instructions to one of the set of reservation stations may comprise: assigning, via a central processing unit (CPU) or a streaming mode compute unit (SMCU), each of the set of instructions to one of the set of reservation stations.

At 1412, the CPU may output an indication to transfer each of the set of instructions from the buffer to one of the set of reservation stations, as described in connection with the examples in FIGS. 1-12. For example, as described in 1260 of FIG. 12, CPU 1202 may output an indication to transfer each of the set of instructions from the buffer to one of the set of reservation stations. Further, step 1412 may be performed by processing unit 120 in FIG. 1. For example, CPU 1202 may output indication 1262 to GPU/CPU 1204.

At 1414, the CPU may remove, based on the indication, each of the set of instructions from the buffer for transfer to one of the set of reservation stations, as described in connection with the examples in FIGS. 1-12. For example, as described in 1270 of FIG. 12, CPU 1202 may remove, based on the indication, each of the set of instructions from the buffer for transfer to one of the set of reservation stations. Further, step 1414 may be performed by processing unit 120 in FIG. 1. For example, CPU 1202 may remove instructions 1272 from memory 1206. In some aspects, removing each of the set of instructions from the buffer may comprise: dequeuing, from the buffer, each of the set of instructions for the transfer to one of the set of reservation stations. Also, at 1414, the CPU may send, from the buffer based on the removal, each of the set of instructions to one of the set of reservation stations, as described in connection with the examples in FIGS. 1-12. For example, as described in 1270 of FIG. 12, CPU 1202 may send, from the buffer based on the removal, each of the set of instructions to one of the set of reservation stations. Further, step 1414 may be performed by processing unit 120 in FIG. 1. For example, CPU 1202 may send instructions 1272 to GPU/CPU 1204. In some instances, sending each of the set of instructions to one of the set of reservation stations may comprise: enqueuing, in one of the set of reservation stations, each of the set of instructions.

At 1416, the CPU may output an indication of assignment of each of the set of instructions to one of the set of reservation stations, as described in connection with the examples in FIGS. 1-12. For example, as described in 1280 of FIG. 12, CPU 1202 may output an indication of assignment of each of the set of instructions to one of the set of reservation stations. Further, step 1416 may be performed by processing unit 120 in FIG. 1. In some aspects, outputting the indication of the assignment of each of the set of instructions to one of the set of reservation stations may comprise transmitting the indication of the assignment of each of the set of instructions to one of the set of reservation stations. For example, CPU 1202 may transmit indication 1282 to GPU/CPU 1204. Also, outputting the indication of the assignment of each of the set of instructions to one of the set of reservation stations may comprise storing the indication of the assignment of each of the set of instructions to one of the set of reservation stations. For example, CPU 1202 may store indication 1284 in memory 1206.

In configurations, a method or an apparatus for graphics processing is provided. The apparatus may be a CPU (or other central processor), a streaming mode compute unit (SMCU), a GPU (or other graphics processor), a DDIC, an apparatus for data processing, and/or some other processor that may perform data or graphics processing. In aspects, the apparatus may be the processing unit 120 within the device 104, or may be some other hardware within the device 104 or another device. The apparatus, e.g., processing unit 120, may include means for obtaining a set of instructions for data storage, where the set of instructions is associated with the data processing. The apparatus, e.g., processing unit 120, may also include means for storing each of the set of instructions in a buffer, where the buffer is associated with a set of reservation stations. The apparatus, e.g., processing unit 120, may also include means for assigning each of the set of instructions to one of the set of reservation stations based on storage of each of the set of instructions in the buffer. The apparatus, e.g., processing unit 120, may also include means for determining at least one of a first available reservation station of the set of reservation stations or a corresponding reservation station of the set of reservation stations for each of the set of instructions. The apparatus, e.g., processing unit 120, may also include means for outputting an indication to transfer each of the set of instructions from the buffer to one of the set of reservation stations. The apparatus, e.g., processing unit 120, may also include means for removing, based on the indication, each of the set of instructions from the buffer for transfer to one of the set of reservation stations. The apparatus, e.g., processing unit 120, may also include means for sending, from the buffer based on the removal, each of the set of instructions to one of the set of reservation stations. The apparatus, e.g., processing unit 120, may also include means for configuring the set of reservation stations for the storage of the set of instructions in the buffer. The apparatus, e.g., processing unit 120, may also include means for outputting an indication of assignment of each of the set of instructions to one of the set of reservation stations.

The subject matter described herein may be implemented to realize one or more benefits or advantages. For instance, the described data processing techniques may be used by a CPU, a central processor, an SMCU, a GPU, or some other processor that may perform data processing to implement the buffer sharing techniques described herein. This may also be accomplished at a low cost compared to other data processing techniques. Moreover, the data processing techniques herein may improve or speed up graphics processing or execution. Further, the data processing techniques herein may improve resource or data utilization and/or resource efficiency. Additionally, aspects of the present disclosure may utilize buffer sharing techniques in order to improve memory bandwidth efficiency and/or increase processing speed at a CPU, an SMCU, a GPU, or a DPU.

It is understood that the specific order or hierarchy of blocks in the processes / flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for data processing, including at least one memory and at least one processor coupled to the at least one memory and, based at least in part on information stored in the at least one memory, the at least one processor, individually or in any combination, is configured to: obtain a set of instructions for data storage, wherein the set of instructions is associated with the data processing; store each of the set of instructions in a buffer, wherein the buffer is associated with a set of reservation stations; and assign each of the set of instructions to one of the set of reservation stations based on storage of each of the set of instructions in the buffer.

Aspect 2 is the apparatus of aspect 1, wherein to assign each of the set of instructions to one of the set of reservation stations, the at least one processor is configured to: assign, via a linked list, each of the set of instructions to one of the set of reservation stations.

Aspect 3 is the apparatus of aspect 2, wherein the linked list includes a linear collection of a set of data elements, where a current data element in the set of data elements holds a data pointer for a subsequent data element in the set of data elements.

Aspect 4 is the apparatus of any of aspects 2 to 3, wherein to assign, via the linked list, each of the set of instructions to one of the set of reservation stations, the at least one processor is configured to: map, via the linked list, each of the set of instructions to one of the set of reservation stations.

Aspect 5 is the apparatus of any of aspects 1 to 4, wherein the at least one processor is further configured to: determine at least one of a first available reservation station of the set of reservation stations or a corresponding reservation station of the set of reservation stations for each of the set of instructions.

Aspect 6 is the apparatus of aspect 5, wherein to assign each of the set of instructions to one of the set of reservation stations, the at least one processor is configured to: map each of the set of instructions to the corresponding reservation station of the set of reservation stations.

Aspect 7 is the apparatus of any of aspects 5 to 6, wherein to assign each of the set of instructions to one of the set of reservation stations, the at least one processor is configured to: assign each of the set of instructions to the first available reservation station of the set of reservation stations.

Aspect 8 is the apparatus of any of aspects 1 to 7, wherein the at least one processor is further configured to: output an indication to transfer each of the set of instructions from the buffer to one of the set of reservation stations.

Aspect 9 is the apparatus of aspect 8, wherein the at least one processor is further configured to: remove, based on the indication, each of the set of instructions from the buffer for transfer to one of the set of reservation stations.

Aspect 10 is the apparatus of aspect 9, wherein the at least one processor is further configured to: send, from the buffer based on the removal, each of the set of instructions to one of the set of reservation stations.

Aspect 11 is the apparatus of aspect 10, wherein to send each of the set of instructions to one of the set of reservation stations, the at least one processor is configured to: enqueue, in one of the set of reservation stations, each of the set of instructions.

Aspect 12 is the apparatus of any of aspects 9 to 11, wherein to remove each of the set of instructions from the buffer, the at least one processor is configured to: dequeue, from the buffer, each of the set of instructions for the transfer to one of the set of reservation stations.

Aspect 13 is the apparatus of any of aspects 1 to 12, wherein to assign each of the set of instructions to one of the set of reservation stations, the at least one processor is configured to: assign, via a central processing unit (CPU) or a streaming mode compute unit (SMCU), each of the set of instructions to one of the set of reservation stations.

Aspect 14 is the apparatus of any of aspects 1 to 13, wherein the at least one processor is further configured to: configure the set of reservation stations for the storage of the set of instructions in the buffer.

Aspect 15 is the apparatus of aspect 14, wherein to configure the set of reservation stations for the storage of the set of instructions in the buffer, the at least one processor is configured to: map the set of reservation stations for the storage of the set of instructions in the buffer.

Aspect 16 is the apparatus of any of aspects 1 to 15, wherein the set of instructions includes at least one of: a set of vector instructions (VX), a set of matrix instructions (MX), or a set of move instructions (MU).

Aspect 17 is the apparatus of any of aspects 1 to 16, wherein the buffer is at least one of a single data buffer, a shared data buffer, or a single shared data buffer, and wherein the set of instructions is a plurality of data instructions.

Aspect 18 is the apparatus of any of aspects 1 to 17, wherein to store each of the set of instructions in the buffer, the at least one processor is configured to: store each of the set of instructions in the buffer at a central processing unit (CPU) or a streaming mode compute unit (SMCU).

Aspect 19 is the apparatus of any of aspects 1 to 18, wherein the at least one processor is further configured to: output an indication of assignment of each of the set of instructions to one of the set of reservation stations.

Aspect 20 is the apparatus of aspect 19, wherein to output the indication of the assignment of each of the set of instructions to one of the set of reservation stations, the at least one processor is configured to: transmit the indication of the assignment of each of the set of instructions to one of the set of reservation stations; or store the indication of the assignment of each of the set of instructions to one of the set of reservation stations.

Aspect 21 is the apparatus of aspect 20, further including (i.e., comprising) at least one of an antenna or a transceiver coupled to the at least one processor, wherein to transmit the indication of the assignment of each of the set of instructions to one of the set of reservation stations, the at least one processor is configured to: transmit, via at least one of an antenna or a transceiver, the indication of the assignment of each of the set of instructions to one of the set of reservation stations.

Aspect 22 is the apparatus of any of aspects 1 to 21, wherein the apparatus is a wireless communication device.

Aspect 23 is a method of data processing for implementing any of aspects 1 to 21.

Aspect 24 is an apparatus for data processing including means for implementing any of aspects 1 to 21.

Aspect 25 is a computer-readable medium (e.g., a non-transitory computer-readable medium) storing computer executable code (e.g., code for data processing), the code when executed by at least one processor causes the at least one processor to implement any of aspects 1 to 21.

What is claimed is:

1. An apparatus for data processing, comprising:
at least one memory; and
at least one processor coupled to the at least one memory and, based at least in part on information stored in the at least one memory, the at least one processor is configured to:
obtain a set of instructions for data storage, wherein the set of instructions is associated with the data processing;
store each of the set of instructions in a buffer, wherein the buffer is associated with a set of reservation stations; and
assign each of the set of instructions to one of the set of reservation stations based on storage of each of the set of instructions in the buffer.

2. The apparatus of claim 1, wherein to assign each of the set of instructions to one of the set of reservation stations, the at least one processor is configured to:
assign, via a linked list, each of the set of instructions to one of the set of reservation stations.

3. The apparatus of claim 2, wherein the linked list includes a linear collection of a set of data elements, where a current data element in the set of data elements holds a data pointer for a subsequent data element in the set of data elements.

4. The apparatus of claim 2, wherein to assign, via the linked list, each of the set of instructions to one of the set of reservation stations, the at least one processor is configured to:
map, via the linked list, each of the set of instructions to one of the set of reservation stations.

5. The apparatus of claim 1, wherein the at least one processor is further configured to:
determine at least one of a first available reservation station of the set of reservation stations or a corresponding reservation station of the set of reservation stations for each of the set of instructions.

6. The apparatus of claim 5, wherein to assign each of the set of instructions to one of the set of reservation stations, the at least one processor is configured to:
map each of the set of instructions to the corresponding reservation station of the set of reservation stations.

7. The apparatus of claim 5, wherein to assign each of the set of instructions to one of the set of reservation stations, the at least one processor is configured to:
assign each of the set of instructions to the first available reservation station of the set of reservation stations.

8. The apparatus of claim 1, wherein the at least one processor is further configured to:
output an indication to transfer each of the set of instructions from the buffer to one of the set of reservation stations.

9. The apparatus of claim 8, wherein the at least one processor is further configured to:
remove, based on the indication, each of the set of instructions from the buffer for transfer to one of the set of reservation stations.

10. The apparatus of claim 9, wherein the at least one processor is further configured to:
send, from the buffer based on the removal, each of the set of instructions to one of the set of reservation stations.

11. The apparatus of claim 10, wherein to send each of the set of instructions to one of the set of reservation stations, the at least one processor is configured to:
enqueue, in one of the set of reservation stations, each of the set of instructions.

12. The apparatus of claim 9, wherein to remove each of the set of instructions from the buffer, the at least one processor is configured to:
dequeue, from the buffer, each of the set of instructions for the transfer to one of the set of reservation stations.

13. The apparatus of claim 1, wherein to assign each of the set of instructions to one of the set of reservation stations, the at least one processor is configured to:
assign, via a central processing unit (CPU) or a streaming mode compute unit (SMCU), each of the set of instructions to one of the set of reservation stations.

14. The apparatus of claim 1, wherein the at least one processor is further configured to:
configure the set of reservation stations for the storage of the set of instructions in the buffer.

15. The apparatus of claim 14, wherein to configure the set of reservation stations for the storage of the set of instructions in the buffer, the at least one processor is configured to:
map the set of reservation stations for the storage of the set of instructions in the buffer.

16. The apparatus of claim 1, wherein the set of instructions includes at least one of a set of vector instructions (VX), a set of matrix instructions (MX), or a set of move instructions (MU), wherein the buffer is at least one of a single data buffer, a shared data buffer, or a single shared data buffer, and wherein the set of instructions is a plurality of data instructions.

17. The apparatus of claim 1, wherein to store each of the set of instructions in the buffer, the at least one processor is configured to:
store each of the set of instructions in the buffer at a central processing unit (CPU) or a streaming mode compute unit (SMCU).

18. The apparatus of claim 1, wherein the at least one processor is further configured to:
output an indication of assignment of each of the set of instructions to one of the set of reservation stations.

19. A method of data processing, comprising:
obtaining a set of instructions for data storage, wherein the set of instructions is associated with the data processing;
storing each of the set of instructions in a buffer, wherein the buffer is associated with a set of reservation stations; and
assigning each of the set of instructions to one of the set of reservation stations based on storage of each of the set of instructions in the buffer.

20. A computer-readable medium storing computer executable code for data processing, the code when executed by at least one processor causes the at least one processor to:
obtain a set of instructions for data storage, wherein the set of instructions is associated with the data processing;
store each of the set of instructions in a buffer, wherein the buffer is associated with a set of reservation stations; and
assign each of the set of instructions to one of the set of reservation stations based on storage of each of the set of instructions in the buffer.
